(19) United States
(12) Patent Application Publication
(10) Pub. No.: US 2026/0312212 A1
(43) Pub. Date: Oct. 8, 2026

(54) GROOVE-MOUNTED CELL STACK SUPPORT ASSEMBLY

(71) Applicant: Ford Global Technologies, LLC, Dearborn, MI (US)

(72) Inventors: Jie Deng, Novi, MI (US); Mihir Devendra Upadhye, Ann Arbor, MI (US); Liam E. West, Ferndale, MI (US); Pradeep Elumalai, Northville, MI (US)

(21) Appl. No.: 19/172,857

(22) Filed: Apr. 8, 2025

(51) Int. Cl. H01M 50/291; H01M 10/613; H01M 10/625; H01M 10/647; H01M 10/6557; H01M 10/6567; H01M 10/658; H01M 50/209; H01M 50/249; H01M 50/262; H01M 50/293

(52) U.S. Cl. CPC H01M 50/291; H01M 10/613; H01M 10/625; H01M 10/647; H01M 10/6557; H01M 10/6567; H01M 10/658; H01M 50/249; H01M 50/262; H01M 50/293; H01M 50/209

(57) ABSTRACT

A battery pack assembly includes an enclosure assembly and a support assembly of a cell stack. The support assembly has a first fin and a second fin. The first fin and the second fin each have a peripheral portion that is at least partially received within a groove of the enclosure assembly.

### TECHNICAL FIELD

This disclosure details exemplary support assemblies used to support a cell stack within an enclosure assembly of a traction battery pack and, more particularly, to how the support assemblies are mounted.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. As part of an immersion thermal management system, liquid coolant can be moved through the traction battery pack to help manage thermal energy within the traction battery pack.

### SUMMARY

In some aspects, the techniques described herein relate to a battery pack assembly, including: an enclosure assembly; and a support assembly of a cell stack, the support assembly having a first fin and a second fin, the first fin and the second fin each having a peripheral portion that is at least partially received within a groove of the enclosure assembly.

In some aspects, the techniques described herein relate to a battery pack assembly, further including an adhesive bonding both the peripheral portion of the first fin and the peripheral portion of the second fin to the enclosure assembly.

In some aspects, the techniques described herein relate to a battery pack assembly, wherein the first fin and the second fin each have a C-shaped cross-sectional profile.

In some aspects, the techniques described herein relate to a battery pack assembly, wherein the first fin opens in a first axial direction, wherein the second fin opens in an opposite, second axial direction.

In some aspects, the techniques described herein relate to a battery pack assembly, wherein the first fin and the second fin each have a divider section, and at least one support section extending transversely from the divider section.

In some aspects, the techniques described herein relate to a battery pack assembly, wherein the first fin has a first fin divider section and at least one first fin support section extending transversely from the first fin divider section in a first axial direction, wherein the second fin has a second fin divider section and at least one second fin support section extending from the second fin divider section in an opposite, second axial direction.

In some aspects, the techniques described herein relate to a battery pack assembly, wherein the first fin and the second fin are metal or metal-alloy fins.

In some aspects, the techniques described herein relate to a battery pack assembly, wherein the first fin and the second fin are aluminum.

In some aspects, the techniques described herein relate to a battery pack assembly, wherein the support assembly supports a plurality of battery cells of the cell stack in an elevated position where the plurality of battery cells are spaced from the enclosure assembly.

In some aspects, the techniques described herein relate to a battery pack assembly, wherein the peripheral portion is an upper peripheral portion, and the groove is a cover groove within an enclosure cover of the enclosure assembly, the first fin and the second fin each including a lower peripheral portion that is received within a tray groove within an enclosure tray of the enclosure assembly.

In some aspects, the techniques described herein relate to a battery pack assembly, wherein the first fin is attached directly to the second fin.

In some aspects, the techniques described herein relate to a battery pack assembly, wherein the first fin is welded to the second fin.

In some aspects, the techniques described herein relate to a battery pack assembly, further including a plurality of pieces of material sandwiched between the first fin and the second fin to establish coolant channels that extend through the cell stack.

In some aspects, the techniques described herein relate to a battery pack assembly, wherein the plurality of pieces of material are a plurality of strips of mica.

In some aspects, the techniques described herein relate to a battery pack assembly, wherein the support assembly includes first and second thermal barrier layers that sandwich both the first fin and the second fin.

In some aspects, the techniques described herein relate to a battery pack assembly, wherein the cell stack includes a plurality of battery cells disposed along an axis, the support assembly having a divider section that extends between battery, and a flange extending transversely from the divider section.

In some aspects, the techniques described herein relate to a battery pack assembly, wherein the cell stack is at least partially immersed in a dielectric liquid coolant.

In some aspects, the techniques described herein relate to a battery pack assembly, wherein the support assembly supports the cell stack within the enclosure assembly at a position where battery cells of the cell stack are spaced from an enclosure tray of the enclosure assembly and are spaced from an enclosure cover of the enclosure assembly.

In some aspects, the techniques described herein relate to a battery pack assembly, including: an enclosure assembly holding a dielectric immersion coolant; at least one first battery cell of a cell stack; at least one second battery cell of the cell stack; and a support assembly that supports the cell stack within an enclosure assembly, the support assembly disposed axially between the at least one first battery cell and the at least one second battery cell, the support assembly having a first peripheral portion bonded to a first groove of the enclosure assembly on a first side of the cell stack, and a second peripheral portion bonded to a second groove of the enclosure assembly on an opposite, second side of the cell stack.

In some aspects, the techniques described herein relate to a battery pack assembly, wherein the first peripheral portion and the second peripheral portion each include areas of both a first fin and a second fin, wherein the first fin and the second fin each have a C-shaped cross-sectional profile.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective, schematic view of a battery array from the battery pack of FIG. 1.

FIG. 3 illustrates an expanded view of the battery array of FIG. 2.

FIG. 4 illustrates a section view of the battery array taken at line 4-4 in FIG. 2 and showing a portion of a cell stack disposed between an enclosure cover and an enclosure tray.

FIG. 5 illustrates a close-up view of an area of FIG. 4 and showing a portion of a support assembly from the cell stack according to an exemplary embodiment of the present disclosure.

FIG. 6 illustrates a close-up view of another area of FIG. 4 and shows another portion of the support assembly according to the exemplary embodiment.

FIG. 7 illustrates a perspective view of a portion of the support assembly from FIGS. 5 and 6.

FIG. 8 illustrates a perspective view of a fin according to another exemplary embodiment of the present disclosure.

FIG. 9 illustrates the fin of FIG. 8 when installed with a battery pack.

FIG. 10 illustrates a support assembly according to another exemplary embodiment of the present disclosure.

FIG. 11 illustrates a perspective view of a fin according to another exemplary embodiment of the present disclosure.

FIG. 12 illustrates the fin of FIG. 11 when installed with a battery pack.

### DETAILED DESCRIPTION

An immersion thermal management system can be used to manage thermal energy in a traction battery pack. In such a traction battery pack, at least some components of the traction battery pack are immersed in a liquid coolant within an enclosure. The immersed components can include a cell stack.

This disclosure is directed toward a support assembly utilized to support a cell stack of a traction battery pack. The support assembly can include a fin mounted within a groove of an enclosure structure. The battery pack can be an immersion-cooled battery pack.

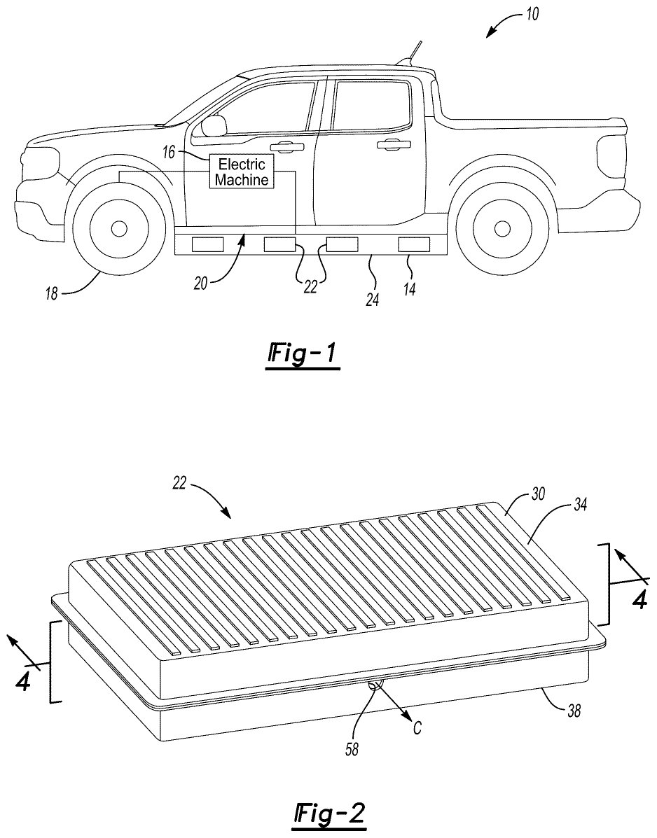

With reference to FIG. 1, an electrified vehicle 10 includes a traction battery pack 14, an electric machine 16, and wheels 18. The traction battery pack 14 powers the electric machine 16, which can convert electrical power to mechanical power to drive the wheels 18. The traction battery pack 14 can be a relatively high-voltage battery.

The traction battery pack 14 is, in the exemplary embodiment, secured to an underbody 20 of the electrified vehicle 10. The traction battery pack 14 could be located elsewhere on the electrified vehicle 10 in other examples. In the exemplary embodiment, the traction battery pack 14 includes one or more battery arrays 22 housed within a pack enclosure 24.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

FIGS. 2-4 illustrate additional detail of one of the arrays 22 from the battery pack 14. In this example, the array 22 includes an array enclosure assembly 30 having enclosure structures —here a cover 34 and a tray 38. The cover 34, in this example, is vertically above the tray 38. In other examples, however, the cover 34 could be arranged below, or to a side of the tray 38. The array 22 and its array enclosure assembly 30 are contained within the pack enclosure 24. The array enclosure assemblies 30 hold liquid coolant within the pack enclosure 24. The cover 34 and the tray 38 can be cast.

Various terms such as “vertical,” “above,” “below,” “top,” and “bottom” are used relative to the arrangement of the components of the battery array 22 in the various drawings and should not otherwise be deemed limiting. These terms are with reference to the general orientation of the battery array 22 when installed within the vehicle 10 of FIG. 1,

The cover 34 is welded to the tray 38 in one example of this disclosure. While welding is mentioned, the cover 34 and tray 38 could be connected using other fluid-tight connection techniques, such as adhesive. Further, while an exemplary enclosure assembly 30 is shown in the drawings, the enclosure assembly 30 may vary in size, shape, and configuration within the scope of this disclosure.

In this disclosure, a cell stack 42 is arranged within an interior of the enclosure assembly 30. The example cell stack 42 includes a plurality of individual battery cells 46 disposed along a cell stack axis A, and a plurality of support assemblies 50. In this example, each of the support assemblies 50 is sandwiched between two of the battery cells 46 along the cell stack axis A. The battery cells 46 and support assemblies 50 can be compressed along the cell stack axis A between a pair of endplates 52.

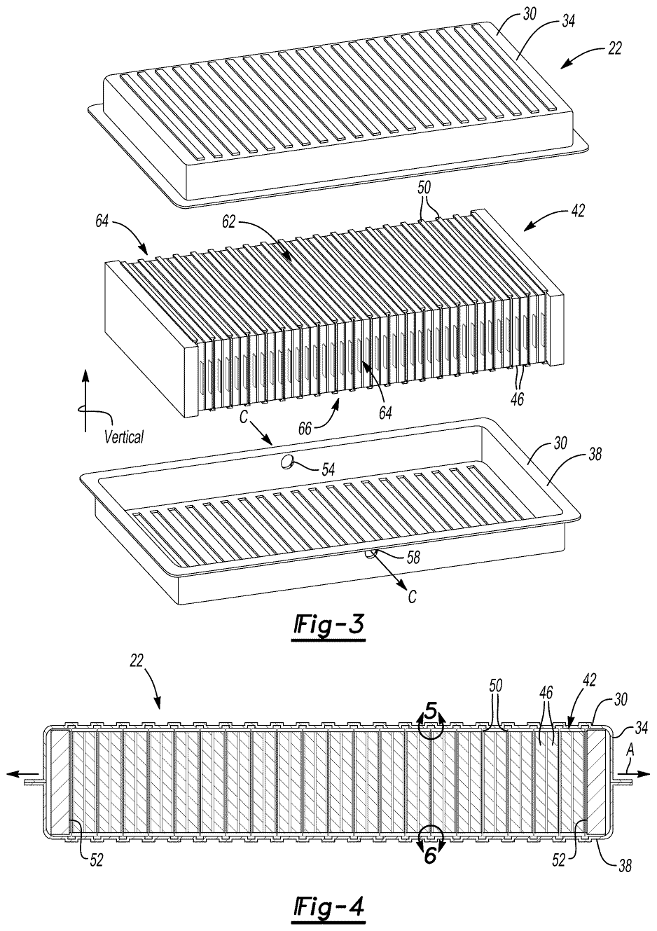

The cell stack 42 could include any number of battery cells 46. The battery array 22 could be expanded to employ multiple cell stacks 42 within the enclosure assembly 30. Thus, this disclosure is not limited to the exact configuration shown in FIG. 2. Further, while the battery cells 46 and support assemblies 50 of FIG. 3 are positioned side-by-side relative to one another, other configurations are also contemplated within the scope of this disclosure, including but not limited to embodiments in which the battery cells 46 and support assemblies 50 are stacked on top of one another, for example.

In the exemplary embodiment, the battery cells 46 are pouch-style, lithium-ion cells. However, battery cells having other geometries (cylindrical, prismatic, etc.), other chemistries (nickel-metal hydride, lead-acid, etc.), or both could alternatively be utilized within the scope of this disclosure.

The cell stack 42 is arranged in the interior of the enclosure assembly 30 between the tray 38 and the cover 34. A thermal management system is used to manage thermal energy levels within the battery array 22 and its cell stack 42. The example thermal management system is configured to route non-conductive (i.e., dielectric) coolant C into the interior of the enclosure assembly 30 and over areas of the cell stack 42 to manage thermal energy within the cell stack 42 by, for example, using the coolant C to take on heat from the cell stack 42. The thermal management system is an immersion thermal management system at least because portions of the battery array 22, here at least the battery cells 46 of the cell stack 42 are immersed in the coolant C.

In this example, the coolant C generally flows from an inlet 54, to an outlet 58, which is on an opposite side of the cell stack 42. The cell stack 42 has a top side 62, opposing outboard sides 64, and a bottom side 66.

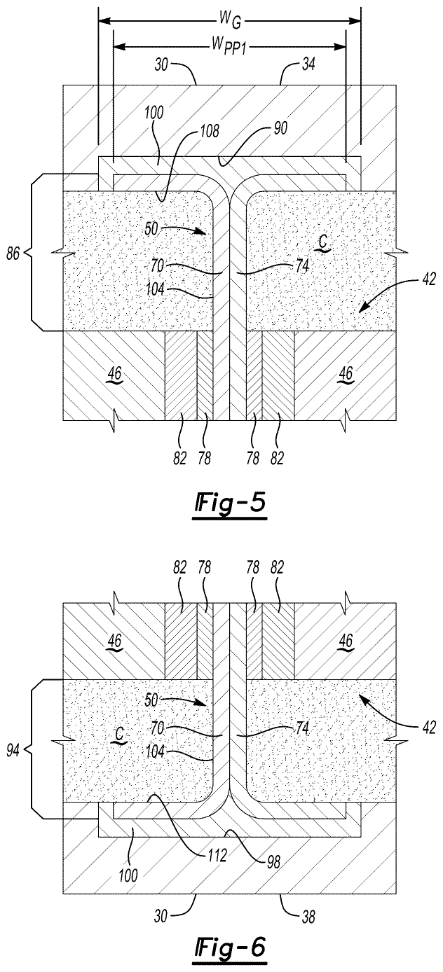

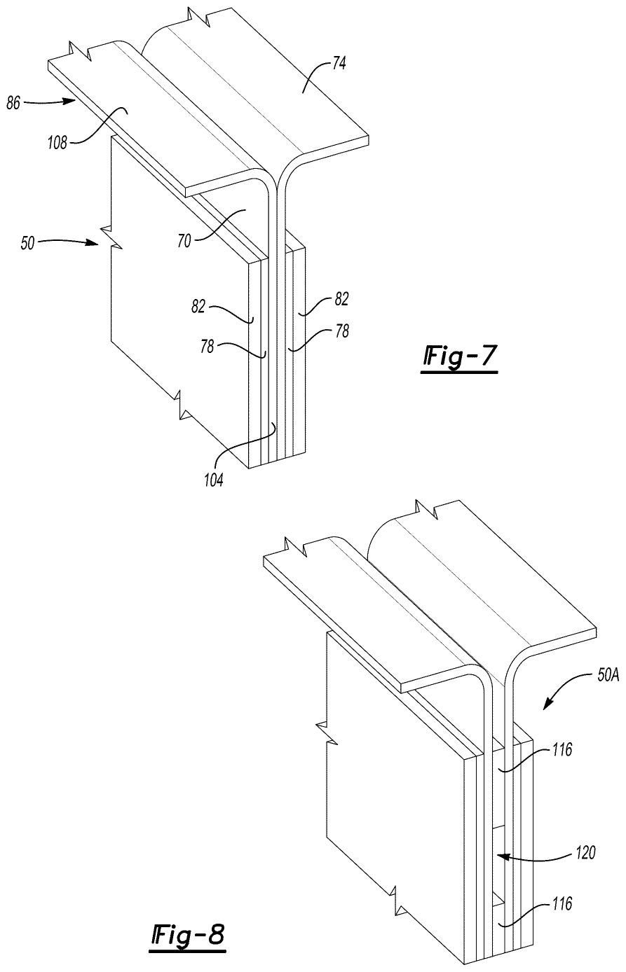

With reference now to FIGS. 5-7 and continuing reference to FIGS. 2-4, some of the coolant C communicates within the interior of the enclosure assembly 30 over a vertical top of the cell stack 42 as shown in FIG. 5. Some of the coolant C communicates beneath the cell stack 42 as shown in FIG. 6. Thermal energy can transfer back-and-forth between the coolant C and the battery cells 46 and between the coolant C and other components as the coolant C moves through the interior of the enclosure assembly 30.

The coolant C can be a dielectric liquid coolant. The coolant C can be used to cool the battery cells 46 and other components. In some examples, the coolant C can be used to heat the battery cells 46 and other components.

The support assemblies 50 can support weight of the cell stack 42 in a position spaced vertically upward from the enclosure tray 38 and spaced vertically downward from the enclosure cover 34 to locate the cell stack 42 within the enclosure assembly 30. The support assembly 50 can be said to support the cell stack 42 in an elevated position.

The support assemblies 50 of the exemplary embodiment each include a first fin 70 attached directly to a second fin 74. The first fin 70 and the second fin 74 area sandwiched between layers of a thermal barrier 78 and layers of foam 82.

In this example, the first fins 70 and the second fin 74 each have a C-shaped cross-sectional profile. The first fin 70 and the second fin 74 are arranged back-to-back such that the first fin 70 opens in a first axial direction and the second fin 74 opens in an opposite, second direction—this gives the support assemblies 50 an “I” shape.

The first fin 70 and the second fin 74 can be a metal or metal-alloy and can be connected to each other via welds. The first fin 70 and the second fin 74 can be considered thermal fins. The first fin 70 and the second fin 74 can be stamped to provide the C-shape. In a specific example, the first fin 70 and the second fin 74 are aluminum.

The first fin 70 includes a first peripheral portion 86 or upper peripheral portion that projects vertically upward past the battery cells 46 and is at least partially received within a groove 90 of the enclosure cover 34. The first fin 70 includes a second peripheral portion 94 or lower peripheral portion that projects vertically downward beneath the battery cells 46 and is at least partially received within a groove 98 of the enclosure tray 38.

Adhesive 100 is utilized to bond the first peripheral portion 86 to the enclosure cover 34, and to bond the second peripheral 94 to the enclosure tray 38. The adhesive 100 can be a low viscosity, structural adhesive 100 with good thermally conductive properties.

During assembly, the adhesive 100 can be deposited within the respective grooves 90 and 98 of the enclosure assembly 30. Prior to the adhesive 100 curing, the first peripheral portion 86 is moved into the adhesive 100 within the groove 90 and the second peripheral portion 94 is moved at least partially into the groove 98. The adhesive 100 can then cure to bond the first peripheral portion 86 to the enclosure cover 34 and the second peripheral portion 80 to the enclosure tray 38.

In the exemplary embodiment, the first fin 70 includes a divider section 104, a first flange 108 at a first end of the divider section 104, and a second flange 112 at an opposite, second end of the divider section 104. The divider section 104 is the portion of the exemplary first fin 70 that extends vertically and passes between the battery cells 46 of the cell stack 42. The first flange 108 and the second flange 112 extend transversely from opposing ends of the divider section 104 to provide the first fin 70 with the C-shape cross-sectional profile. A width W_{G} of the groove 90 is from 10 to 15 percent longer than a width W_{PP1} of the first peripheral portion 86 of the support assembly 50. Appropriately sizing the groove 90 relative to the first peripheral portion 86 can facilitate assembly and can help to achieve adequate strength of adhesive 100 for bonding the first peripheral portion 86 to the cover 3 within the groove 90. The relatively wide interface between the support assembly 50 and the enclosure assembly 30 can help to improve bonding strength and facilitate transfer of thermal energy from the first fin 70 and the second fin 74 to the enclosure assembly 30. In this example, the width W_{G} of the groove 90 and the groove 98 in the enclosure tray 38 is from 10 to 15 millimeters, which leaves about 1 to 2 millimeters on either side of the support assembly 50 within the groove 98.

The first peripheral portion 86 includes some of the divider section 104 and the first flange 108. The second peripheral portion 94 includes some of the divider section 104 and the second flange 112.

In this example, the first flange 108 extends at a 90-degree angle from the divider section 104. Similarly, the second flange 112 extends at a 90-degree angle away from the divider section 104. Angles other than 90 degrees are possible and could be utilized in other examples. In the exemplary embodiment, the first flange 108 and the second flange 112 each extend in a direction parallel to the cell stack axis A.

The second fin 74 is constructed similarly to the first fin 70, with first and second flanges extending from opposing ends of a divider section. In this example, the divider section 104 of the first fin 70 is the portion of the first fin 70 that is directly connected to the second fin 74.

When the support assembly 50 is installed, adhesive can be used to bond the first fin 70 and the second fin 74 to the to the thermal barrier 78, The layers of foam 82 can also be adhesively bonded to the thermal barrier 78 and the battery cells 46. and the layers of foam 82.

With reference now to FIGS. 8 and 9, a support assembly 50A according to another exemplary aspect of the present disclosure, includes a plurality of separate pieces of material 116 sandwiched between a first fin 70A and a second fin 74B. The pieces of material 116 can be a strips of a thermal barrier material, such as mica. The pieces of material 116 can be strips of foam.

The open areas between the pieces of material 116 can establish channels 120 between the first fin 70A and the second fin 70B. The channels 120 can be used to communicate the coolant C through a cell stack 142A having the support assembly 50A.

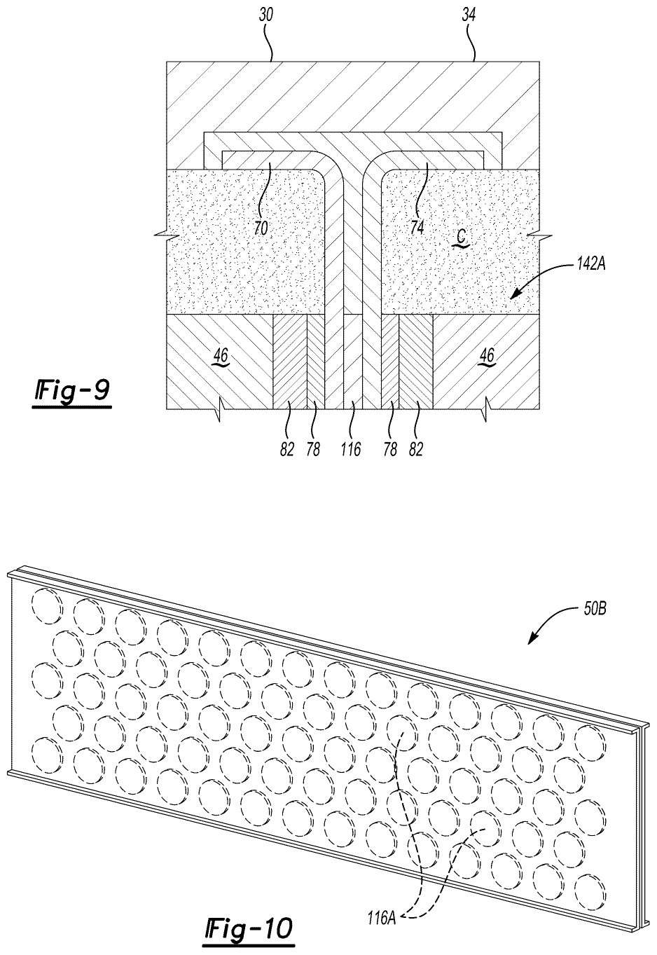

The pieces of material 116 are strips in the example of FIGS. 8 and 9. In the example of FIG. 10, a support assembly 50B includes pieces 116A sandwiched between a first fin and a second fin. The pieces 116A are disk-shaped pieces of material. The pieces 116A are circular in this example. In other examples, the pieces 116A can have another shape.

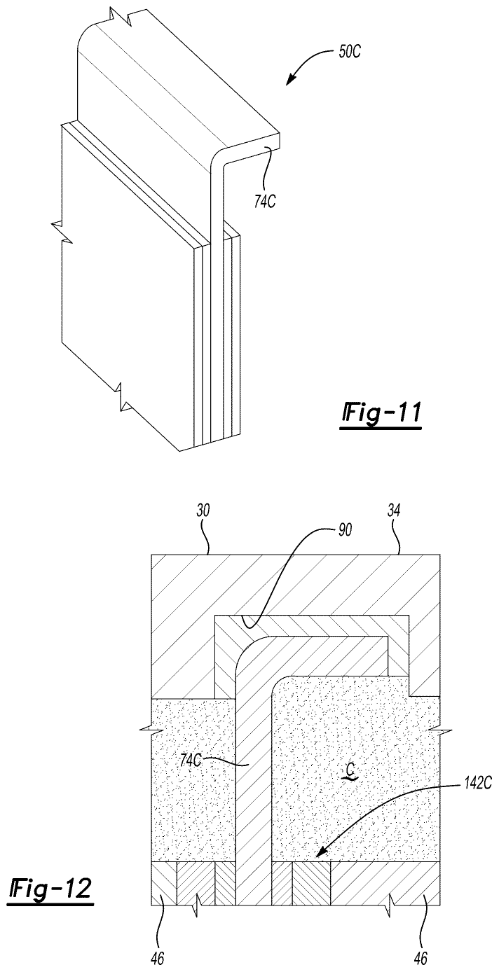

With reference now to FIGS. 11 and 12, yet another example support assembly 50C omits the first fin 70 or the second fin 74. The support assembly 50C includes a fin 74C having a peripheral portion 86C received within the groove 90 above battery cells of the cell stack 142C.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack assembly, comprising:
an enclosure assembly; and
a support assembly of a cell stack, the support assembly having a first fin and a second fin, the first fin and the second fin each having a peripheral portion that is at least partially received within a groove of the enclosure assembly.

2. The battery pack assembly of claim 1, further comprising an adhesive bonding both the peripheral portion of the first fin and the peripheral portion of the second fin to the enclosure assembly.

3. The battery pack assembly of claim 1, wherein the first fin and the second fin each have a C-shaped cross-sectional profile.

4. The battery pack assembly of claim 3, wherein the first fin opens in a first axial direction, wherein the second fin opens in an opposite, second axial direction.

5. The battery pack assembly of claim 1, wherein the first fin and the second fin each have a divider section, and at least one support section extending transversely from the divider section.

6. The battery pack assembly of claim 1, wherein the first fin has a first fin divider section and at least one first fin support section extending transversely from the first fin divider section in a first axial direction, wherein the second fin has a second fin divider section and at least one second fin support section extending from the second fin divider section in an opposite, second axial direction.

7. The battery pack assembly of claim 1, wherein the first fin and the second fin are metal or metal-alloy fins.

8. The battery pack assembly of claim 1, wherein the first fin and the second fin are aluminum.

9. The battery pack assembly of claim 1, wherein the support assembly supports a plurality of battery cells of the cell stack in an elevated position where the plurality of battery cells are spaced from the enclosure assembly.

10. The battery pack assembly of claim 1, wherein the peripheral portion is an upper peripheral portion, and the groove is a cover groove within an enclosure cover of the enclosure assembly, the first fin and the second fin each including a lower peripheral portion that is received within a tray groove within an enclosure tray of the enclosure assembly.

11. The battery pack assembly of claim 1, wherein the first fin is attached directly to the second fin.

12. The battery pack assembly of claim 11, wherein the first fin is welded to the second fin.

13. The battery pack assembly of claim 1, further comprising a plurality of pieces of material sandwiched between the first fin and the second fin to establish coolant channels that extend through the cell stack.

14. The battery pack assembly of claim 13, wherein the plurality of pieces of material are a plurality of strips of mica.

15. The battery pack assembly of claim 1, wherein the support assembly includes first and second thermal barrier layers that sandwich both the first fin and the second fin.

16. The battery pack assembly of claim 1, wherein the cell stack includes a plurality of battery cells disposed along an axis, the support assembly having a divider section that extends between battery, and a flange extending transversely from the divider section.

17. The battery pack assembly of claim 1, wherein the cell stack is at least partially immersed in a dielectric liquid coolant.

18. The battery pack assembly of claim 1, wherein the support assembly supports the cell stack within the enclosure assembly at a position where battery cells of the cell stack are spaced from an enclosure tray of the enclosure assembly and are spaced from an enclosure cover of the enclosure assembly.

19. A battery pack assembly, comprising:
an enclosure assembly holding a dielectric immersion coolant;
at least one first battery cell of a cell stack;
at least one second battery cell of the cell stack; and
a support assembly that supports the cell stack within an enclosure assembly, the support assembly disposed axially between the at least one first battery cell and the at least one second battery cell, the support assembly having a first peripheral portion bonded to a first groove of the enclosure assembly on a first side of the cell stack, and a second peripheral portion bonded to a second groove of the enclosure assembly on an opposite, second side of the cell stack.

20. The battery pack assembly of claim 19, wherein the first peripheral portion and the second peripheral portion each include areas of both a first fin and a second fin, wherein the first fin and the second fin each have a C-shaped cross-sectional profile.
